(19) United States
(12) Patent Application Publication
(10) Pub. No.: US 2013/0143014 A1
(43) Pub. Date: Jun. 6, 2013

(54) SHAPE RETAINING FILM AND PRODUCTION METHOD THEREFOR, LAMINATED FILM-TAPE, SELF-ADHESIVE FILM-TAPE, ANISOTROPIC THERMAL CONDUCTIVE FILM, AND SHAPE RETAINING FIBER

(71) Applicants: Tamio Kawasumi, Chiba-shi (JP); Michio Eriguchi, Chiba-shi (JP); Shigeo Nishikawa, Chiba-shi (JP)

(72) Inventors: Tamio Kawasumi, Chiba-shi (JP); Michio Eriguchi, Chiba-shi (JP); Shigeo Nishikawa, Chiba-shi (JP)

(73) Assignee: MITSUI CHEMICALS INC., Minato-ku ,Tokyo (JP)

(21) Appl. No.: 13/816,605

(22) PCT Filed: Aug. 24, 2011
(86) PCT No.: PCT/JP2011/004709

§ 371 Date: Feb. 12, 2013

(30) Foreign Application Priority Data
Aug. 25, 2010 (JP) 2010-188374

(51) Int. Cl. B32B 27/32; B32B 27/08; D02G 3/04; B32B 27/30

(52) U.S. Cl. CPC B32B 27/32; B32B 27/30; B32B 27/08; D02G 3/045
USPC 428/213; 428/515; 428/518; 428/220; 264/291

(57) ABSTRACT

The purpose of the present invention is to provide a shape retaining film excellent in shape retention, and further having high tensile elasticity and good longitudinal tear resistance. The shape retaining film is composed of at least one base material layer containing an ethylene polymer that has the density of 900 kg/m³ or more, and the weight-average molecular weight (Mw)/number-average molecular weight (Mn) of 5 to 20, and at least one soft layer containing a high polymer material. The ethylene polymer is an ethylene homopolymer or an ethylene-α-olefin copolymer in which the content of a-olefin unit having 3 to 6 carbon atoms is less than 2% by weight, The high polymer material has the melting point (Tm2) lower than the melting point (Tm1) of the ethylene polymer, the tensile elasticity of 10 to 50 GPa, and the recovery angle of 65° or less as a result of 180° bending, test.

### TECHNICAL FIELD

The present invention relates to shape-retaining films and processes for producing the same, laminated films/tapes, adhesive films/tapes, anisotropic heat-conductive films, and shape-retaining fibers.

### BACKGROUND ART

Containers for foods such as instant noodles and puddings are required to have shape retainability—an ability with which they can keep the lid open or closed. Aluminum and other metals have heretofore been employed as the lid materials for such containers. However, attempts have been made to replace aluminum materials with shape-retaining resin films because of some drawbacks of aluminum, including requirement of time-consuming separate disposal and inapplicability to products that are heated in a microwave oven with water poured in the container.

As shape-retaining resin films, films prepared by uniaxially stretching polyethylene have been proposed (see, e.g., Patent Literature 1). Moreover, in addition to usage as shape-retaining films, uniaxially-stretched polyethylene films are known to be used as easy-tearing films for food packaging (see e.g., Patent Literature 2).

It has been reported that shape-retaining resin fibers can be prepared by micro-slitting of uniaxially-stretched polyethylene films that have a glossy layer laminated thereon (see, e.g., Patent Literature 3),

### CITATION LIST

### Patent Literature

[PTL 1] Japanese Patent Application Laid-Open No. 2007-153361
[PTL 2] Japanese Patent Application Laid-Open No. 2004-181878
[PTL 3] Japanese Patent Application Laid-Open No. 2009-30219

### SUMMARY OF INVENTION

### Technical Problem

However, the shape-retaining films disclosed by Patent Literatures 1 to 3 do not necessarily exhibit sufficiently high shape retainability and/or high tensile modulus of elasticity Further, these shape-retaining films have the drawback of being apt to tear along its stretch direction (i.e., longitudinal direction).

Shape-retaining fibers are required to exhibit higher shape retainability as well as appropriate levels of modulus of elasticity, thermal conductivity and/or other properties suitable for the intended applications. For example, shape-retaining fibers used in fabrics are required to have such a modulus of elasticity that they can be interwoven. When the fabrics are used for clothes and/or the like, the shape-retaining fibers may also be required to exhibit high thermal conductivity.

Known fibers that have high thermal conductivity include carbon fibers and ultra high molecular weight polyethylene fibers. However, not only they are expensive but their modulus of elasticity is extremely high, making it difficult for them to be woven into a fabric.

It is conceivable to process inexpensive general-purpose polyethylenes into fibers that exhibit a low modulus of elasticity because of their low intrinsic viscosity [η], but they exhibit poor melt spinnability. Thus, although there have been cases where general-purpose polyethylenes are employed as the core material or sheath material of core-sheath fibers, it has been difficult in the art to form fibers only with polyethylene. Although core-sheath fibers in which polyethylene is used as the sheath material offer a certain, but is still insufficient, level of thermal conductivity. Moreover, it is difficult to confer shape retainability to core-sheath fibers in which polyethylene is used as the core material or as the sheath material.

The claimed invention has been made in an effort to solve the foregoing problems pertinent in the art. Namely, a first aspect of the claimed invention provides a shape-retaining film that exhibits superior shape retainability as well as high tensile modulus of elasticity and good lengthwise tear resistance; a laminated film/tape, an adhesive film/tape, and an anisotropid heat-conductive film having the shape-retaining film; and a process for producing the shape-retaining film. A second aspect of the claimed invention provides a shape-retaining fiber that exhibits superior shape retainability and such a tensile modulus of elasticity that it can be woven into a fabric, as well as high thermal conductivity.

### Solution to Problem

Namely, the claimed invention enables to provide the following shape-retaining film, process for producing the shape-retaining film, laminated tape, anisotropic heat-conductive film, and shape-retaining fiber.

[1] A shape-retaining film including:

at least one base layer containing an ethylene polymer, the ethylene polymer having a density of 900 kg/m³ or more and a ratio of weight-average molecular weight (Mw) to number-average molecular weight (Mn) of 5 to 20; and

at least one soft layer containing a polymer material,

wherein the ethylene polymer is either an ethylene homopolymer or an ethylene-α-olefin copolymer containing less than 2 wt % C₃₋₆ α-olefin unit,

wherein a melting point Tm2 of the polymer material is lower than a melting point Tm1 of the ethylene polymer, and

wherein the shape-retaining film has a tensile modulus of elasticity of 10 to 50 GPa, and an angle of recovery from 180° bending of 65° or less.

[2] The shape-retaining film according to [1], wherein the shape-retaining film is a laminate in which the soft layer is directly laminated onto one side of the base layer.

[3] The shape-retaining film according to [1], wherein the shape-retaining film is a laminate in which the at least one base layer comprises two base layers, and the soft layer is provided between the two base layers.

[4] The shape-retaining film according to any one of [1] to [3], wherein the melting point Tm2 of the polymer material is lower than the melting point Tm1 of the ethylene polymer by 5° C. or more.

[5] The shape-retaining film according to any one of [1] to [4], wherein the melting point Tm2 of the polymer material is 125° C. or below.

[6] The shape-retaining film according to any one of [1] to [5], wherein the polymer material is at least one polymer material selected from the group consisting of a hydrocarbon plastic, a vinyl plastic, and a thermoplastic elastomer.

[7] The shape-retaining film according to any one of [1] to [6], wherein an overall thickness of the soft layer is 5 to 40% of an overall thickness of the base layer.

[8] The shape-retaining film according to any one of [1] to [7], wherein the shape-retaining film is a uniaxially-stretched film.

[9] The shape-retaining film according to [8], wherein a tensile modulus of elasticity in stretch direction of the shape-retaining film is 10 to 50 GPa, and a tensile modulus of elasticity in a direction substantially perpendicular to the stretch direction is 6 GPa or less.

[10] The shape-retaining film according to any one of [1] to [9], wherein the shape-retaining film has a thickness of 20 to 100 μm.

A process for producing the shape-retaining film according to any one of [1] to [10], including:

a first step of providing an original film, the original film including at least one base layer containing an ethylene polymer, the ethylene polymer having a density of 900 kg/m³ or more and a ratio of weight-average molecular weight (Mw) to number-average molecular weight (Mn) of 5 to 20, and at least one soft layer containing a polymer material, the ethylene polymer being either an ethylene homopolymer or an ethylene-α-olefin copolymer containing less than 2 wt % C₃₋₆ α-olefin unit, a melting point Tm2 of the polymer material being lower than a melting point Tm1 of the ethylene polymer; and

a second step of stretching the original film at a stretch ratio of 10 to 30,

[12] A laminated tape including:

the shape-retaining film according to any one of [1] to [10]; and a tacky layer disposed on a partial or entire surface of at least one side of the shape-retaining film.

[13] An anisotropic heat-conductive film including the shape-retaining film according to any one of [1] to [10].

[14] A shape-retaining fiber including:

at least one base layer containing an ethylene polymer, the ethylene polymer having a density of 900 kg/m³ or more and a ratio of weight-average molecular weight (Mw) to number-average molecular weight (Mn) of 5 to 20; and

at least one soft layer containing a polymer material,

wherein the ethylene polymer is either an ethylene homopolymer or an ethylene-α-olefin copolymer containing less than 2 wt % C₃₋₆ α-olefin unit,

wherein a melting point Tm2 of the polymer material is lower than a melting point Tm1 of the ethylene polymer, and

wherein the shape-retaining fiber has a tensile modulus of elasticity of 10 to 50 GPa, and an angle of recovery from 90° lengthwise bending of 35° or less.

### Advantageous Effects of Invention

A shape-retaining film of the claimed invention exhibits superior shape retainability as well as high tensile modulus of elasticity and good lengthwise tear resistance. A shape-retaining fiber of the claimed invention exhibits superior shape retainability and such a tensile modulus of elasticity that the fiber can be woven into a fabric, as well as high thermal conductivity.

### BRIEF DESCRIPTION OF DRAWINGS

FIGS. 1A and 1B are schematic views illustrating a method of measuring an angle of recovery from 180° bending;

FIG. 2 is a perspective view illustrating an example of a packaging material;

FIGS. 3A and 3B illustrate an example of the physical relationship among a heat source, an anisotropic heat-conductive film, and a heat dissipator;

FIG. 4 is a schematic view illustrating an example of an electronic device having therein an anisotropic heat-conductive film of the claimed invention;

FIG. 5 is a schematic view illustrating another example of an electronic device having therein an anisotropic heat-conductive film of the claimed invention;

FIGS. 6A and 6B are schematic views illustrating a method of measuring an angle of recovery from 90° bending;

FIG. 7 is an optical microscopic image of a cross-section of a uniaxially-stretched film obtained in Example 1;

FIG. 8 is a graph showing a plot of tear strength (mN) versus low melting material content (wt %) in film; and

FIG. 9 is a graph showing a plot of angle of recovery (°) versus low melting material content (wt %) in film.

### DESCRIPTION OF EMBODIMENTS

1. Shape-Retaining Film

A shape-retaining film of the claimed invention includes at least one base layer containing a particular ethylene polymer, and at least one soft layer containing a polymer material whose melting point is lower than the melting point of the ethylene polymer (i.e., a low melting material). Each component will now be described.

(Base Layer)

The base layer contains a particular ethylene polymer. Preferably, the base layer consists of the ethylene polymer. The ethylene polymer is an ethylene homopolymer or an ethylene-α-olefin copolymer. Copolymerization of small amounts of α-olefin with ethylene achieves increased moldability. The α-olefins to be copolymerized with ethylene are C₃₋₆ α-olefins. Examples of the C₃₋₆ α-olefins include propylene, 1-butene, and 1-hexene, with propylene being preferable. The α-olefin unit content in the ethylene-α-olefin copolymer is less than 2 wt %, more preferably 0.05 to 1.5 wt %.

The density of the ethylene polymer is 900 kg/m³ or more, preferably 930 kg/m³ or more, and more preferably 950 kg/m³ or more; general-purpose high-density polyethylene (HDPE) may be employed. A density of less than 900 kg/m³ makes it difficult to provide shape retainability by means of stretching. On the other hand, when the density is too high, the resin becomes more difficult to be molded into a film by melt casting. Thus, although the upper limit of the density of the ethylene polymer is not particularly limited, it is virtually on the order of 970 to 980 kg/m³. When the base layer consists of the ethylene polymer, the density of the ethylene polymer is the density of the base layer. The density of the ethylene polymer (base layer) can be measured in accordance with JIS K7112 D using an ethanol-water solution as immersion solution.

The ratio of weight-average molecular weight (Mw) to number-average molecular weight (Mn), Mw/Mn, a measure of molecular weight distribution, of the ethylene polymer ranges from 5 to 20, preferably 6 to 16, and more preferably 7 to 14. When the molecular weight distribution is too narrow, it results in reduced film stretchability making it difficult to stretch the resultant film at a high stretch ratio. On the other hand, when the molecular weight distribution is too broad, low-molecular weight components are abundant, which may reduce the mechanical strength of the resultant film or may contaminate the stretcher to reduce productivity.

The molecular weight distribution (Mw/Mn) of the ethylene polymer can be measured by gel permeation chromatography (GPC).

The melt flow rate (MFR) of the ethylene polymer is preferably 0.1 to 3.0 g/10 min, more preferably 0.5 to 1.5 g/10 min, as measured at 190° C. under a load of 2,160 g. When the melt flow rate of the ethylene polymer falls within any of the aforementioned ranges, the ethylene polymer exhibits moderate flowability during melt casting carried, facilitating formation of a film having uniform thickness.

Thus, ethylene polymers that have a relatively high density and an appropriate molecular weight distribution are easily formed into films that can be stretched at a high stretch ratio and therefore exhibit superior shape retainability.

The base layer may additionally contain thermoplastic resins other than the aforementioned ethylene polymer and/or various additives as long as they do not compromise the effects of the claimed invention. Examples of the additives include coloring pigments, inorganic fillers, antioxidants, neutralizers, lubricants, antistatic agents, anti-blocking agents, water resisting agents, water repellents, antibacterial agents, and processing aids (e.g., waxes).

The inorganic fillers are, for example, glass fibers, glass beads, talc, silica, mica, calcium carbonate, magnesium hydroxide, alumina, zinc oxide, magnesium oxide, magnesium hydroxide, aluminum hydroxide, titanium oxide, calcium oxide, calcium silicate, molybdenum sulfide, antimony oxide, clay, diatom earth, calcium sulfate, asbestos, iron oxide, barium sulfate, magnesium carbonate, dolomite, montmorillonite, bentonite, iron powder, aluminum powder, and carbon black. The processing aids are, for example, waxes such as low-molecular weight polyolefins and alicylic polyolefins.

The processing aid or antistatic agent may be present in an amount of, for example, 5wt % or less, preferably 1 wt % or less. The inorganic filler or coloring pigment may be present in an amount of, for example, 10 wt % or less, preferably 5wt % or less.

(Soft Layer)

The soft layer contains a polymer material. Preferably, the soft layer consists of a polymer material.

Melting point Tm2 of the polymer material is lower than melting point Tm1 of the ethylene polymer that constitutes the base layer. Formation of a soft layer using a polymer material that has a lower melting point than the constituent material of the base layer (i.e., low melting material) significantly increases the lengthwise tear resistance of the resultant shape-retaining film.

The melting point Tm2 of the polymer material is preferably lower than the melting point Tm1 of the ethylene polymer by 5° C. or more, more preferably 40° C. or more. When the difference between the melting points Tm1 and Tm2 is too small, the resultant shape-retaining film shows limited increase in lengthwise tear resistance. Moreover, as will be described later, if there is only a small difference in melting point between the two layers, there is a tendency that uniaxial stretching cannot be easily effected at temperatures where the base layer does not easily melt but the soft layer easily melts. The melting point Tm2 of the polymer material is typically 125° C. or below, preferably 90° C. or below.

Examples of the polymer material include hydrocarbon plastics, vinyl plastics, and thermoplastic elastomers. These polymer materials can be used alone or in combination.

Specific examples of the hydrocarbon plastics include polyethylene, polypropylene, polybutene, polystyrene, and polybutadiene. Specific examples of the vinyl plastics include polyvinyl chloride, polyvinyl acetate, polyvinylidene chloride, ethylene-vinyl acetate copolymers, and polymethylmethacrylate. Specific examples of the thermoplastic elastomers include styrene-butadiene elastomers, polyolefin elastomers, urethane elastomers, polyester elastomers, polyamide elastomers, polyvinyl chloride elastomers, and ionomers.

From the perspective of processability, it is preferable to employ such a polymer material that has a melting point near the melting point of the ethylene polymer of the base layer. More specifically, polyethylene, ethylene-vinyl acetate copolymer, and polyolefin thermoplastic elastomer are preferable. On the other hand, from the perspective of adhesion, it is preferable to employ such a polymer material that has molecular structure similar to that of the ethylene polymer of the base layer. More specifically, polyethylene, ethylene-vinyl acetate copolymer, and polyolefin thermoplastic elastomer are preferable. It is also preferable to employ such a polymer material that exhibits tackiness in order to allow the soft layer to function as a tacky layer. More specifically, polyethylene, ethylene-vinyl acetate copolymer, and polyolefin thermoplastic, elastomer are preferable.

Among the aforementioned polymer materials, a thermoplastic elastomer is preferable as the polymer material; more specifically, it is preferable to employ an α-olefin copolymer prepared by copolymerization of at least two α-olefins selected from the group consisting of ethylene, propylene, 1-butene, and 1-hexene. As the α-olefin copolymer, it is preferable to employ an ethylene-α-olefin copolymer, propylene-α-olefin copolymer, or ethylene-propylene copolymer. The number of carbon atoms of the α-olefin comonomer to be copolymerized with ethylene or propylene is 4 to 6. As the α-olefin copolymer, it is more preferable to employ ethylene-propylene copolymer, ethylene-1-butene copolymer, ethylene-1-hexene copolymer, propylene-1-butene copolymer, propylene-1-hexene copolymer, or 1-butene-1-hexene copolymer. Specific examples thereof are “TAFMER® A” and “TAFMER® P” (Mitsui Chemicals, Inc.).

The soft layer may additionally contain thermoplastic resins other than the aforementioned polymer material and/or additives as long as that do not compromise the effects of the claimed invention. Specific examples of the additives and their added amounts are similar to those for the base layer.

(Shape-Retaining Film)

A shape-retaining film of the claimed invention includes the aforementioned base layer and soft layer. The base layer and soft layer may be laminated together with an adhesive layer or may be directly laminated together without any intervening layer in between the two layers. For enhanced shape retainability, it is preferable that the soft layer be directly laminated onto one side of the base layer without providing any intervening layer that does not contribute to shape retainability, such as an adhesive layer.

Alternatively, the shape-retaining film may be configured as a laminate that includes two base layers (e.g., base layers A and B) and one soft layer provided between the two base layers. Such a three-layered laminate is preferable as it reduces the likelihood of troubles such as unwanted attachment of the soft layer to the roll during stretching and therefore increases production efficiency. When there are two base layers, the ethylene polymers constituting the respective two base layers may be the same or different.

The shape-retaining film of the claimed invention exert not only superior shape retainability by means of the ethylene polymer-containing base layer, but also superior lengthwise tear resistance by combining (laminating) together the base layer and the soft layer containing the polymer material (i.e., low melting material). Formulating a low melting material and/or the like in the constituent material of a shape-retaining film in an attempt to confer to the film shape retainability typically results in the shape-retaining film having increased lengthwise tear resistance but reduced shape retainability. In contrast, the shape-retaining film of the claimed invention is prepared by laminating together the low melting material-containing layer and the base layer, rather than by formulating (blending) the low melting material into the base layer material. This allows the shape-retaining film of the claimed invention to maintain a high level of shape retainability with significantly improved lengthwise tear resistance.

The overall thickness of the soft layer is preferably 5 to 40%, more preferably 10 to 35%, and most preferably 15 to 30% of the overall thickness of the base layer. Adjusting the ratio of the overall thickness of the soft layer with respect to the overall thickness of the base layer to fall within any of the aforementioned ranges provides a good balance between shape retainability and lengthwise tear resistance. When the soft layer is too thick, the shape-retaining film tends to exhibit reduced shape retainability. On the other hand, when the soft layer is too thin, the lengthwise tear resistance of the shape-retaining film tends to decrease,

The shape-retaining film preferably has a thickness of 20 to 100 μm, more preferably 25 to 70 μm.

A shape-retaining film, prepared by stretching (preferably uniaxially stretching) an original film that includes the aforementioned base layer and soft layer at a certain high stretch ratio or above, exhibits a high tensile modulus of elasticity. The shape-retaining film preferably has a tensile modulus of elasticity of 10 to 50 GPa, more preferably 13 to 50 GPa. When the tensile modulus of elasticity of the shape-retaining film is loss than 10 GPa, it becomes difficult to confer to the shape-retaining film a sufficient shape retainability. On the other hand, when the tensile modulus of elasticity exceeds 50 GPa, the shape-retaining film may become breakable. The tensile modulus of elasticity of the shape-retaining film can be controlled by the stretch ratio of the film. For example, the tensile modulus of elasticity of the shape-retaining film can be increased by increasing the stretch ratio.

The shape-retaining film, prepared by stretching (preferably uniaxially stretching) an original film that includes the aforementioned base layer and soft layer at a certain high stretch ratio or above, exhibits a high tensile modulus of elasticity in stretch direction (X direction) and a low tensile modulus of elasticity in the direction that runs substantially perpendicularly to X direction (i.e., Y direction). When the shape-retaining film is a uniaxially-stretched film, X direction corresponds to uniaxially stretching direction, and Y direction corresponds to a direction that runs substantially perpendicularly to the uniaxially stretching direction. The term “substantially perpendicularly” as used herein means that the intersection angle is substantially 90°, encompassing not only a substantially 90° intersection angle, but also intersection angles slightly deviating from 90° intersection angle. The uniaxially stretching direction for the shape-retaining film of the claimed invention can be confirmed as the direction in which molecular chains of the polyethylene polymer are fully extended, as observed for instance by optical microscopy.

The tensile modulus of elasticity in X direction (direction of high tensile modulus of elasticity) of the shape-retaining film is preferably 10 to 50 GPa, more preferably 13 to 40 GPa. When the tensile modulus of elasticity in X direction falls within any of the aforementioned ranges, the shape-retaining film can be suitably used as an anisotropic heat-conductive layer (described later). When the tensile modulus of elasticity in X direction is less than 10 GPa, it is difficult to provide the shape-retaining film with sufficient shape retainability and/or high thermal conductivity. On the other hand, when the tensile modulus of elasticity in X direction exceeds 50 GPa, the shape-retaining film may become breakable.

The tensile modulus of elasticity in Y direction (direction of low tensile modulus of elasticity) of the shape-retaining film is preferably 6 GPa or less. When the tensile modulus of elasticity in Y direction exceeds 6 GPa, the anisotropy in the thermal conductivity of the shape-retaining film decreases as the thermal conductivity in Y direction increases to approach that in X direction making it difficult for the shape-retaining film to be used as an anisotropic heat-conductive film (described later). The tensile modulus of elasticity in Y direction of the shape-retaining film depends on the type of resin contained therein as a primary component, and does not change largely according to the stretch ratio (in X direction) of the film.

The tensile modulus of elasticity of the shape-retaining film can be measured in accordance with JIS K7161. More specifically, a test specimen is prepared by cutting the shape-retaining film into a strip which is 10 mm in width (dimension in the direction perpendicular to the direction in which molecular chains of polyethylene arc fully extended) and 120 mm in length (dimension in the direction in which molecular chains of polyethylene are fully extended), and then this sample is measured for tensile modulus of elasticity using a tensile tester under the following condition: temperature=23° C., chuck-to-chuck distance=100 mm, and tensile rate=100 mm/min.

The shape-retaining film of the claimed invention exhibits superior shape retainability owing to its high tensile modulus of elasticity. The shape-retaining film exhibits an angle of recovery from 180° bending of 65° or less, preferably 50° or less. The lower limit of the angle of recovery is not particularly limited, but is substantially on the order of 5°.

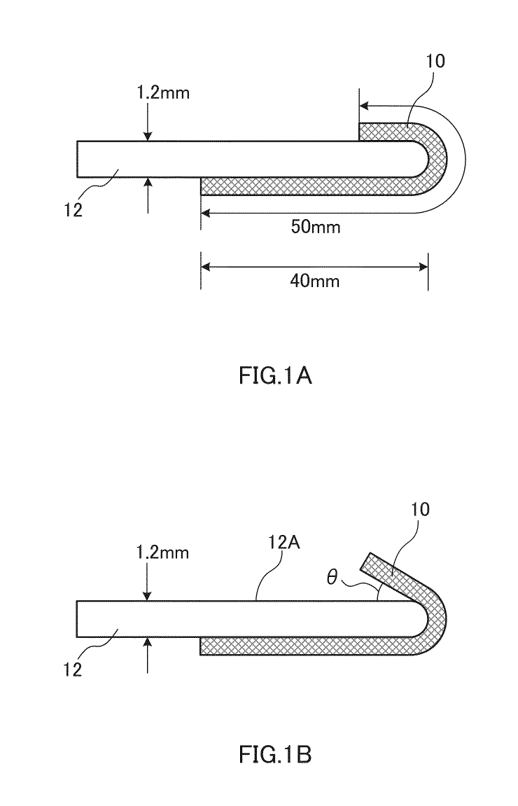

The angle of recovery from 180° bending of the shape-retaining film can be measured in the procedure described below. Specifically, 1) a test specimen is prepared that measures 10 mm in width (dimension in the direction perpendicular to the stretch direction) and 50 mm in length (dimension in the stretch direction); 2) the test specimen is bent at 180° along the bottom, lateral and top surfaces of a plate and kept bent for about 30 seconds (see FIG. 1A); and 3) 30 seconds after releasing the bending force on film, angle θ between the test specimen and the top surface of the plate is measured (see FIG. 1B). The angle of recovery from 180° bending can be measured at 23° C. and 55% relative humidity.

The shape-retaining film of the claimed invention exhibits superior lengthwise tear resistance. More specifically, the tear strength of the shape-retaining film of the claimed invention (i.e., the force required to cause tearing in a direction substantially parallel to the direction in which molecular chains of polyethylene are fully extended) is preferably 50 mN or more, more preferably 200 mN or more. The upper limit of the tear strength is not particularly limited; the higher the tear strength is, the more preferable the film is. In practice, the upper limit of the tear strength is on the order of 2,000 mN.

The tear strength of the shape-retaining film can be measured in the procedure described below. Specifically, using a tear tester (e.g., Elmendorf tear tester (TOYO SEIKI SEISAKU-SHO, Ltd., F.S=1,000 mN)), a test specimen that comprise a pack of 16 film pieces, each measuring in 63 mm in width, and 75 mm in length and having a 20 mm initial cut, is torn in a direction parallel to the direction in which molecular chains of polyethylene are fully extended, and the force required to cause tearing is measured to find the tear strength.

2. Process for Producing Shape-Retaining Film

A shape-retaining film of the claimed invention can be produced by a process that includes: 1) a first step of providing an original film that includes at least one base layer containing the ethylene polymer, and at least one soft layer containing the polymer material; and 2) a second step of stretching (preferably uniaxially stretching) the original film at a stretch ratio of 10 to 30.

The original film can be obtained for instance by melt-kneading of the raw materials of the base layer and soft layer in an extruder, and excluding the molten material from a die onto a cooling roll for solidification. The temperature of the cooling roll is set to a level sufficient to solidify the molten resin to some extent; it is set to, for example, on the order of 80° C. to 120° C. The thickness of the original film is, for example, on the order of 200 to 1,000 μm.

The original film is fed in a roll stretcher, pre-heated with a pre-heating roll, and uniaxially stretched in MD direction. For increased production efficiency, the original film is preferably stretched in MD direction immediately after it is pre-heated. The stretching is preferably uniaxial tensile stretching. The term “uniaxial stretching” as used herein means stretching in a single axis direction. However, the film may also be stretched in different directions than the intended single axis direction as long as the effects of the claimed invention are not compromised. Some stretching machines cause stretching in a single axis direction as well as in substantially different directions than the single axis direction, even when stretching only in the single axis direction is intended.

The stretch ratio is 10 or more, preferably 15 to 30. A stretch ratio of less than 10 results in failure to provide sufficient shape retainability because the shape-retaining film fails to show a sufficient increase in tensile modulus of elasticity.

In order to realize stretching at such a stretch ratio, it is important to appropriately adjust the heating temperature during pre-heating and stretching, particularly to evenly heat the film in thickness direction. The preheating temperature of the pre-heating roll is set to a level sufficient to soften the original sheet so as to be suitable for stretching; it can be set to, for example, 120° C. to 140° C.,

The stretching is preferably effected at a temperature above the melting point Tm2 of the polymer material contained in the soft layer but below the melting point Tm1 of the ethylene polymer contained in the base layer. When the temperature during stretching is below the melting point Tm2 of the polymer material contained in the soft layer, the soft layer fails to melt making it difficult for the original film to be stretched to an extent that sufficient shape retainability is imparted to the stretched film. On the other hand, when the temperature during stretching exceeds the melting point Tm1 of the ethylene polymer contained in the base layer, it results in failure to stretch molecular chains of the ethylene polymer in a direction substantially parallel to the stretch direction, and therefore, it is impossible to enhance the shape retainability of the stretched film. Stretching can be carried out by making a difference in circumferential speed between the pre-heating roll immediately before starting stretching and the stretching roll, while heating the original film at 120° C. to 140° C. The stretching rate is not particularly limited; it can be set to 100 to 1,000%/sec. Heating of the film during stretching may be either roll heating or radiation heating; however, radiation heating is preferable in view of its easiness with which to evenly heat the film in thickness direction.

Radiation heating can be carried out by directing radiation onto the original film surface from a radiation source. Preferable radiation sources are those capable of heating the original film as evenly as possible in thickness direction; examples thereof include halogen lamps that emit radiation containing many near infrared light components, lasers, and far-infrared heaters. In order to ensure stable stretching when stretching the film at a high stretch ratio, heating is preferably carried out by directing radiation as a silt that runs along the TD direction (widthwise direction) of the original film, by focusing on the original film radiation to a size of 1 cm or less in MD direction (lengthwise direction) using a curved reflector or the like.

In order to prevent slippage of the film during stretching it is preferable to press pinch rolls against the pre-heating roll and stretching roll, respectively. The stretched film may be subjected to annealing treatment where necessary. Annealing treatment can be carried out by bringing the stretched sheet in contact with a heating roll.

3. Applications of Shape-Retaining Film

As mentioned above, the shape-retaining film of the claimed invention exhibits superior shape retainability. Thus, the shape-retaining film of the claimed invention is suitable for use as various types of packaging materials, particularly as food packaging materials. The food packaging materials may he lid materials for air-tightly sealing of containers for such foods as instant noodles and puddings, or may be pouches for packaging snacks or retort foods.

(Laminated Film/Tape)

Further, it is preferable to provide one or more functional layers, including tacky layers, adhesive layers, heat seal layers, heat-insulating layers, heat-resistant layers, weather (light)-resistant layers, chemical resistant layers, gas barrier layers, cushion layers, printable layers, conductive layers, peelable (releasable) layers, light reflection layers, photocatalytic layers, foams, paper, wood, non-woven fabric, metals, and ceramics, on a partial or entire surface of at least one side of the shape-retaining film, to fabricate a laminated film/tape.

(Adhesive Film/Tape)

In particular, among laminated films/tapes, an adhesive film/tape having an adhesive layer can be used as a shrink tape, packing tape, bundling tape (e.g., for wire harness bundling), packaging tape, office tape, tape for daily necessities (e.g., for disposable diapers, sports), masking tape (e.g., for paints, protective purposes), surface protection tape (e.g., for optics, FPC protective films), anticorrosion tape, electrically insulating tape, double-sided tape, medical tape (e.g., adhesive bandage), tape for electronic equipment, identification tape, decorative tape (e.g., for media, graphic displays, marking), tape for construction and building materials (for heat ray shield, sound isolation, glass scatter prevention), tape for automotives, heat-conduction tape (e.g., heat dissipation tape), label, or seal.

(Packaging Material)

Since the shape-retaining film of the claimed invention exhibits high shape retainability and lengthwise tear resistance, it is suitable as a packaging material for foods, detergents, etc., as well as a packaging material for refills. Moreover, elimination of any metal foil such as aluminum foil from the packaging material renders it suitable also as a packaging material for microwave oven cooking.

Namely, the packaging material is a bag or tube that includes the aforementioned shape-retaining film. The bag form thereof is not particularly limited; examples include gusset bags used for coffee, tea, and noodles; standing pouches (self-standing bags) used for shampoos; and pillow bags used for snacks and other foods.

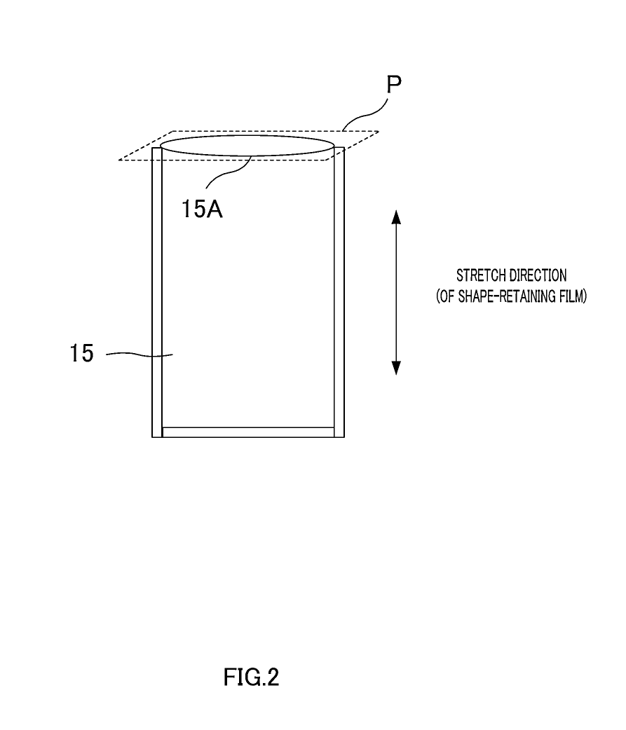

FIG. 2 illustrates an example of a packaging material in the form of bag. As illustrated in FIG. 2, packaging material 15 is so designed that opening plane P intersects the stretch direction of the shape-retaining film of the packaging material, preferably substantially perpendicularly to the stretch direction. Opening plane P of packaging material 15 refers to a plane including opening 15A. The term “substantially perpendicularly” encompasses an intersection angle of 90° as well as intersection angles slightly deviating from 90° intersection angle.

The shape-retaining film constituting packaging material 15 exhibits high shape retainability in a direction parallel to the stretch direction. Thus, formation of opening 15A of packaging material 15 such that opening plane P intersects, preferably substantially perpendicularly intersects, the stretch direction of the shape-retaining film allows packaging material 15 to be placed in a self-standing position or to be closed by simply folding over opening 15A.

Such a packaging material can be produced by: 1) providing the shape-retaining film; 2) overlaying the shape-retaining film on itself or overlaying the shape-retaining film on another different film (sheet); and 3) sealing sides of the resultant laminate. Such another film (shoot) may be a thermoplastic resin sheet or the like.

Overlaying the shape-retaining film on itself encompasses folding a single shape-retaining film over itself, and overlaying two separate shape-retaining films on top of each other.

A packaging material is obtained by sealing sides of the resultant laminate. Sealing may be effected either by means of adhesive or heat sealing, with heat sealing being preferable. Heat sealing temperature is set to a level sufficient to effect bonding of the shape-retaining film to itself or to another film (sheet); heat sealing temperature is, for example, on the order of 100° C. to 300° C. Seal strength is adjusted by heat sealing temperature, the number of heat sealing operations, heat sealing time, etc.

Any of the heat sealing methods known in the art may be employed; for example, bar sealing, roller sealing, impulse sealing, high-frequency sealing or ultrasonic sealing may be employed.

The packaging material that includes the shape-retaining film of the claimed invention exhibits high shape retainability and high lengthwise tear resistance. The packaging material can thereby be placed in a self-standing position or closed by simply folding over the open end.

One or more other layers, such as gas barrier layers, protection layers or heat seal layers, may be provided on at least one side of the shape-retaining film when used as one of the aforementioned packaging materials. The gas barrier layer may be a metal layer or a resin layer, but is preferably an aluminum foil layer for its lightness, good gas barrier property, etc. The thickness of the aluminum foil layer is set to a level sufficient to provide gas barrier property; it may be set to, for example, on the order of 5 to 20 μm.

The resins used for, the protection layer are not particularly limited; preferable examples thereof include polyesters, polyethylenes, polypropylenes and nylons for their ability of enhancing printability or strength. Preferred among polyesters is polyethylene terephthalate (PET), preferred among polypropylenes is biaxially oriented polypropylene (OPP), and preferred among nylons is oriented nylon (ONy).

As the protection layer, an oriented PET film is suitable. However, due to its high impact resilience (spring back property), the oriented PET film tends to reduce shape retainability. On the other hand, a biaxially oriented polypropylene (OPP) film has high rigidity but has small impact resilience and, therefore, may increase the rigidity or tear resistance of the shape-retaining film without compromising its shape retainability. For these reasons, it is possible to provide a shape-retaining film that exhibits superior rigidity and mechanical strength as well as sustained shape retainability by incorporating the oriented polypropylene film and thinning the oriented PET film as much as possible.

The protection layer may be designed in either a single-layer or multilayer configuration. The thickness of the protection layer (single layer) may be on the order of 5 to 20 μm when polyester is used, and on the order of 10 to 30 μm when polypropylene is used.

The resin constituting the heat seal layer may be, for example, linear low-density polyethylene (LLDPE), low-density polyethylene (LDPE), cast polypropylene (CPP), ionomer, or polystyrene. The thickness of the heat seal layer is preferably 10 to 70 μm.

Although depending on its intended application, the shape-retaining film used for a packaging material preferably includes a layer consisting of the shape-retaining film (i.e., shape-retaining film layer) and the protection layer, and preferably further includes the gas barrier layer. The shape-retaining film layer may be either the outermost layer or intermediate layer, but is preferably the outermost layer. The reason for this is that the shape-retaining film exhibits not only high shape retainability, but also heat sealing property and printability (which is conferred by surface irregularity). For example, when the shape-retaining film layer is the interior surface of a packaging material, the packaging material can be heat-sealed, printings can be performed on the interior surface of the packaging material, and so forth. On the other hand, when the shape-retaining film layer is the exterior surface layer of a packaging material, printing can be easily performed on the exterior surface of the packaging material.

(Anisotropic Heat-Conductive Film)

The shape-retaining film of the claimed invention exhibits a high tensile modulus of elasticity in X direction (stretch direction), and therefore exhibits high thermal conductivity in X direction. Thus, the shape-retaining film of the claimed invention can be used as an anisotropic heat-conductive film. The thermal conductivity in X direction (stretch direction) of the anisotropic heat-conductive film typically exceeds 3.0 W/mk, achieving a high thermal conductivity without having to add heat-conductive fillers or the like. Accordingly, an anisotropic heat-conductive film that includes the shape-retaining film of the claimed invention is soft compared to conventional heat-conductive films containing heat-conductive fillers or the like and exhibits sufficient thermal conductivity even when it is thin.

The anisotropic heat conduction property of the anisotropic heat-conductive film depends on the ratio of thermal conductivity between X and Y directions, [thermal conductivity in X direction]/[thermal conductivity in Y direction]. Thus, in the anisotropic heat-conductive film, the ratio of thermal conductivity between X and Y directions is preferably greater than 1 to 60 or less.

The thermal conductivity in X direction of the anisotropic heat-conductive film is measured in the procedure described below. 1) The anisotropic heat-conductive film is cut into a strip-shaped sample which is 30 mm in length (stretch direction; X direction) and 3 mm in width (direction perpendicular to stretch direction; Y direction); 2) A light-receiving film (thin Bi film, thickness: approximately 1,000 A) is deposited on one side of the strip-shaped sample to prepare a test specimen; 3) The test specimen is measured for thermal diffusivity α(m²/s) at 25° C. in lengthwise direction (X direction) with a thermal diffusivity meter using the AC calorimetric method (“LaserPIT” ULVAC-RIKO, Inc.); 4) The strip-shaped sample is measured for specific heat Cp(J/(kg·K) and density ρ(kg/m³) by differential scanning caloriometry; and 5) The measured values are substituted into the following equation to find thermal conductivity λ(W/mK):

Thermal conductivity λ=α×ρ×Cp

The thermal conductivity in Y direction of the anisotropic heat-conductive film may be measured in the same manner as described above except that: another strip-shaped sample is prepared which is 30 mm in length (dimension in the direction perpendicular to stretch direction; Y direction) and 3 mm in width (dimension in stretch direction; X direction); and this specimen is measured for thermal diffusivity in the lengthwise direction (Y direction).

The thickness of the anisotropic heat-conductive film is preferably 20 to 100 μm, more preferably 30 to 40 μm. When the thickness of the anisotropic heat-conductive film is less than 20 μm, the film becomes susceptible to breakage when accommodated in bent or folded state. On the other hand, when the thickness of the anisotropic heat-conductive film exceeds 100 μm, the film becomes rigid enough not to be easily accommodated in folded state in a small space inside electronic or other devices.

Theoretically, the shape of the anisotropic heat-conductive film is determined based on the ratio of thermal conductivity between X and Y directions. The ratio of dimension L1 in X direction (direction of high tensile modulus of elasticity) to dimension W1 in Y direction (direction of low tensile modulus of elasticity) of the anisotropic heat-conductive film is preferably 60 or less. When the ratio L1/W1 exceeds 60, heat dissipation fails as the heat generated from the heat source cannot be conducted to an end in X direction of the anisotropic heat-conductive film. Moreover, when the value of W1 is too small, it is not possible to prevent heat from being conducted in Y direction of the anisotropic heat-conductive film.

It should be noted that, in practice, the shape of the anisotropic heat-conductive film is also affected by the heat source temperature and physical relationships between the heat source and heat dissipator, as will be described below. By way of example, when it is assumed that a 100° C. heat source is placed at a position corresponding to the center of the anisotropic heat-conductive film for dissipating heat (through a dissipator) from an end in X direction of the anisotropic heat-conductive film at room temperature (approximately 23° C.) the heat can be selectively diffused in X direction and cannot be readily diffused in Y direction in the case where the ratio L1/W1 is set to 2.0 or less, preferably 1.9 or less.

As described above, since the anisotropic heat-conductive film exhibits different thermal conductivities along different directions X and Y, the film is preferably cut out in a shape such that the ratio L1/W1 falls within any of the aforementioned ranges. An anisotropic heat-conductive film out out in such a shape can prevent heat from being conducted in Y direction (direction of low tensile modulus of elasticity) while conducting heat in X direction (direction of high tensile modulus of elasticity).

Moreover, the ratio of dimension L1 in X direction (dimension of high tensile modulus of elasticity) to dimension W1 in Y direction (dimension of low tensile modulus of elasticity) of the anisotropic heat-conductive film is preferably greater than 1.0, more preferably 1.6 or more. When dimension W1 of the anisotropic heat-conductive film is too small (relative to dimension X1 in dimension X) in the case where there is only a limited space for the anisotropic heat-conductive film around the heat source in an electronic or other device, it becomes difficult to accommodate the anisotropic heat-conductive film around the heat source.

The anisotropic heat-conductive film can be rectangular or other shape. Dimension L1 of the anisotropic heat-conductive film indicates a maximum dimension in X direction, and dimension W1 indicates a maximum dimension in Y direction.

The dimensions of the anisotropic heat-conductive film in X and Y directions can be appropriately changed depending on the heat source temperature. When the heat source temperature is high, the heat conducting area is enlarged and therefore the dimensions in X and Y directions are increased while keeping the aforementioned ratio L1/W1 to fall within the aforementioned range. On the other hand, when the heat source temperature is low, the heat conducting area is narrowed and therefore the dimensions in X and Y directions are reduced while keeping the aforementioned ratio L1/W1 to fall within the aforementioned range. In either case, it is only necessary for the dimension of the anisotropic heat-conductive film in X direction to be long enough to allow heat to be conducted at least to the heat dissipator.

As described above, the anisotropic heat-conductive film that includes the shape-retaining film of the claimed invention exhibits high shape retainability and thermal conductivity as well as is easy to be accommodated due to its flexibility. Thus, the anisotropic heat-conductive film of the claimed invention is suitably used in electronic devices, particularly in heat dissipating devices used in electronic devices that have inadequate space around the heat source. With such a heat dissipating device, it is possible to effectively conduct beat from the heat source to the dissipator while preventing the heat from conducting to heat-labile circuits.

Examples of the electronic devices to which the anisotropic heat-conductive film is applicable include household appliances, lightings, PCs, cellular phones, smart phones, digital cameras, game machines, electronic papers, electric vehicles, and hybrid cars. There are no particular limitations to the heat source in the electronic devices; examples thereof include transistors, CPUs, ICs, LEDs, and power devices.

The anisotropic heat-conductive film exhibits good shape retainability and high thermal conductivity as well as consists substantially of resin and thus providing good cool feeling and texture. Accordingly, the anisotropic heat-conductive film of the claimed invention can be used not only for the above-mentioned electronic devices but for daily needs such as clothes (suits, work clothes), masks, hats, and bedclothings.

Further, the anisotropic heat-conductive film of the claimed invention can be used in cryogenic applications Specific examples thereof include components of connectors (e.g., valves) or gloves used for transportation, storage and handling of liquid natural gas or liquid hydrogen; components of low-temperature parts of linear motor cars; frozen storage containers for bodily fluids such as blood, bone marrow fluid and sperm, and cells; components of superconductivity magnetic resonance equipment; components used for rockets and space transportation systems; and components of ultrahigh-density memories, medical diagnostic equipment, accelerators, and nuclear fusion reactors.

Among other applications, the anisotropic heat-conductive film of the claimed invention is suitably used in heat dissipating devices for electronic devices that have heat sources such as heat generating elements. Namely, the heat dissipation device includes the anisotropic heat-conductive film for conducting heat generated from a heat source, and a heat dissipator for removing the heat conducted through the anisotropic heat-conductive film.

The heat dissipator is preferably disposed at one or both ends in X direction (direction of high tensile modulus of elasticity) of the anisotropic heat-conductive film. A multiplicity of heat dissipators may also be disposed in the plane of the anisotropic heat-conductive film along X direction, in addition to the end(s) in X direction (direction of high tensile modulus of elasticity) of the anisotropic heat-conductive film. This improves heat dissipation efficiency of the heat dissipation device.

There are no particular limitations to the heat dissipator, and any of the heat dissipators known in the art can be employed. Examples thereof include cooling devices such as cooling fans, cooling pipes and large-area members made of materials having high thermal conductivity such as metal (e.g., radiator plates and heat sinks). The heat dissipator in an electronic device may be, for example, the device's housing itself.

Such a heat dissipation device can be manufactured by any of the methods known in the art. More specifically, the heat dissipation device can be manufactured by connecting the anisotropic heat-conductive film to the heat dissipator by any of the methods known in the art. Examples of the method of connecting the anisotropic heat-conductive film to the heat dissipator include thermal fusing the film to the heat dissipator, bonding the film to the heat dissipator with any of the adhesives known in the art, and clamping the film with a securing means provided on the heat dissipator. Preferably, the anisotropic heat-conductive film and heat dissipator are connected together such that the base layer of the anisotropic heat-conductive film (shape-retaining film) contacts the dissipator.

The heat source and anisotropic heat-conductive film do not necessary have make contact with each other; however, they preferably make contact with each other for enhanced heat dissipation efficiency.

As described above, a preferred physical relationship among the anisotropic heat-conductive film, heat source and heat dissipator is theoretically determined based on the ratio of thermal conductivity between X and Y directions. Thus, the ratio of L2 to W2 is preferably 30 or less, where L2 is the distance between the heat dissipator and the center of a projection of the heat source on the anisotropic heat-conductive film (or the center of the contact area between the anisotropic heat-conductive film and heat source) in X direction of the anisotropic heat-conductive film, and W2 is the distance across the anisotropic heat-conductive film in Y direction at the center of the projection or contact area. When the ratio L2/W2 exceeds 30, it becomes difficult for heat to be conducted to the heat dissipator disposed at an end in X direction of the anisotropic heat-conductive film due to too large a value for L2, and it becomes difficult to prevent heat from being conducted through the anisotropic heat-conductive film in Y direction due to too small a value for W2.

It should be noted that the actual physical relationship among the anisotropic heat-conductive film, heat source and heat dissipator varies depending on the heat source temperature and surrounding temperature. By way of example, when the anisotropic heat-conductive film is used to dissipate heat generated from a 100° C. heat source at room temperature (approximately 23° C.), the heat can be selectively diffused in X direction and cannot be readily diffused in Y direction in the case where the ratio L2/W2 is set to 1.0 or less, preferably 0.95 or less.

As described above, the anisotropic heat-conductive film of the claimed invention exhibits different thermal conductivities along different directions X and Y (direction of high tensile modulus of elasticity, and direction of low tensile modulus of elasticity). Thus, by adjusting the shape of the anisotropic heat-conductive film and/or the physical relationship among the heat source, anisotropic heat-conductive film and heat dissipator such that L2/W2 falls within any of the aforementioned ranges, it is possible to allow heat, generated from the heat source, to conduct through the anisotropic heat-conductive film efficiently in X direction to reach the heat dissipator and not readily in Y direction,

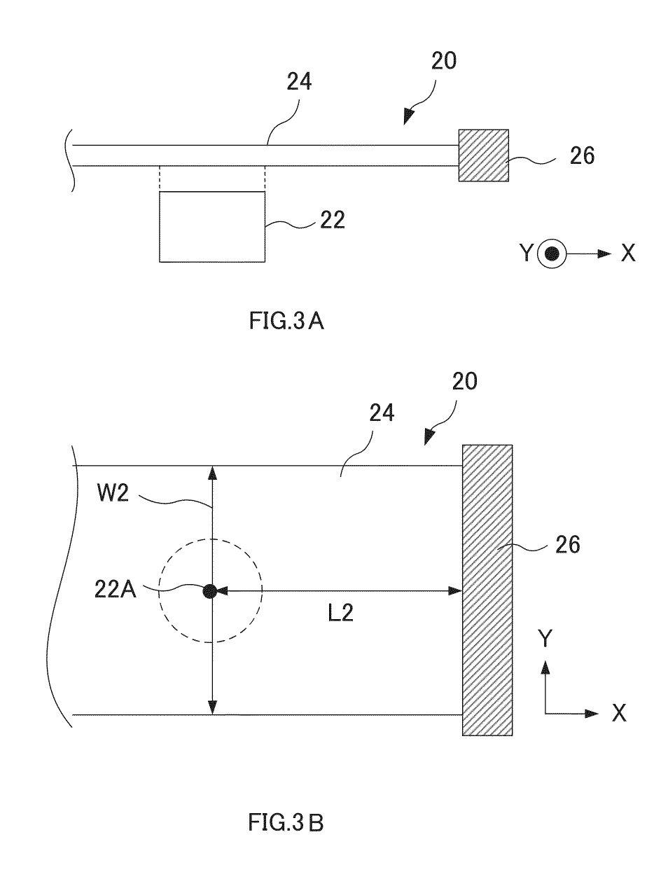

FIGS. 3A and 3B are schematic views illustrating an example of the physical relationship among a heat source, an anisotropic heat-conductive film, and a heat dissipator. FIG. 3A is a side view, and FIG. 3B is a top view. As illustrated in FIGS. 3A and 3B, heat dissipation device 20 that includes anisotropic heat-conductive film 24 and heat dissipator 46 is disposed near heat source 22 such as a heat generating element. The distance between center 22A of a projection of heat source 22 on anisotropic heat-conductive film 24 and heat dissipator 26 in X direction is denoted as L2, and the distance across anisotropic heat-conductive film 24 in Y direction at center 22A of the projection of heat source 22 is denoted as W2.

By disposing heat source 22, anisotropic heat-conductive film 24 and heat dissipator 26 such that L2/W2 falls within any of the aforementioned ranges, heat generated from heat source 22 is well conducted through anisotropic heat-conductive film 24 in X direction (direction of high tensile modulus of elasticity) and is removed by heat dissipator 26. On the other hand, since heat is not easily conducted through anisotropic heat-conductive film 24 in Y direction (direction of low tensile modulus of elasticity), other electric circuits (not shown) near anisotropic heat-conductive film 24 are less likely to be thermally damaged.

The dimensions of the anisotropic heat-conductive film in X and Y directions can be appropriately changed depending on the heat source temperature. When the heat source temperature is high, the heat conducting area is enlarged and therefore the dimensions in X and Y directions are increased while keeping the aforementioned ratio within the aforementioned range. On the other hand, when the heat source temperature is low, the heat conducting area is narrowed and therefore the dimensions in X and Y directions are reduced.

The ratio L2/W2 is preferably greater than 0.5 in view of the ratio of thermal conductivity between X and Y directions, more preferably 0.8 or more. When dimension W2 in Y direction of the anisotropic heat-conductive film is too large (relative to dimension L2 in X direction) in the case where there is only a limited space for the anisotropic heat-conductive film around the heat source in an electronic or other device, it becomes difficult to accommodate the anisotropic heat-conductive film around the heat source.

Dimension W2 of the anisotropic heat-conductive film may vary according to the position in X direction. For example, the dimension in Y direction of the anisotropic heat-conductive film may be increased at positions near heat-labile devices and reduced at other positions.

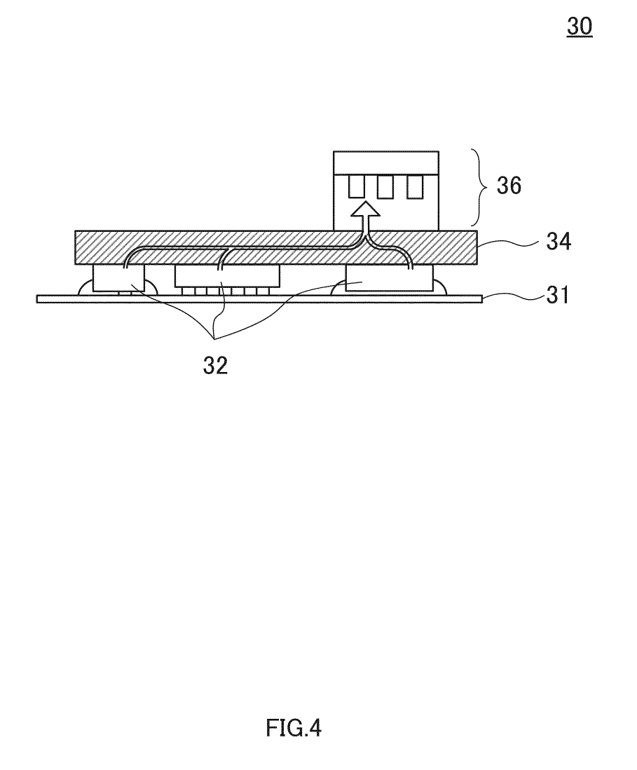

FIG. 4 is a schematic view illustrating an example of an electronic device into which the anisotropic heat-conductive sheet is incorporated. As illustrated in FIG. 4, heat dissipation structure 30 includes anisotropic heat-conductive film 34 which is disposed so as to contact heat sources 32 (e.g., heat generating elements) disposed on printed circuit board 31 and which is disposed parallel to the surface of printed circuit board 31, and heat dissipator 36 disposed so as to contact the surface of anisotropic heat-conductive film 34, which surface is remote from the surface contacting heat sources 32. Anisotropic heat-conductive film 34 can be the anisotropic heat-conductive film of the claimed invention. The lengthwise direction of anisotropic heat-conductive film 34 in FIG. 4 corresponds to X direction (direction of high tensile modulus of elasticity).

In heat dissipation structure 30, anisotropic heat-conductive film 34 exhibits high thermal conductivity in X direction, and therefore, as indicated by the arrow, heat generated from heat sources 32 flows in X direction and is smoothly conducted to heat dissipator 36. The heat conducted through heat-conductive film 34 is then removed by heat dissipator 36.

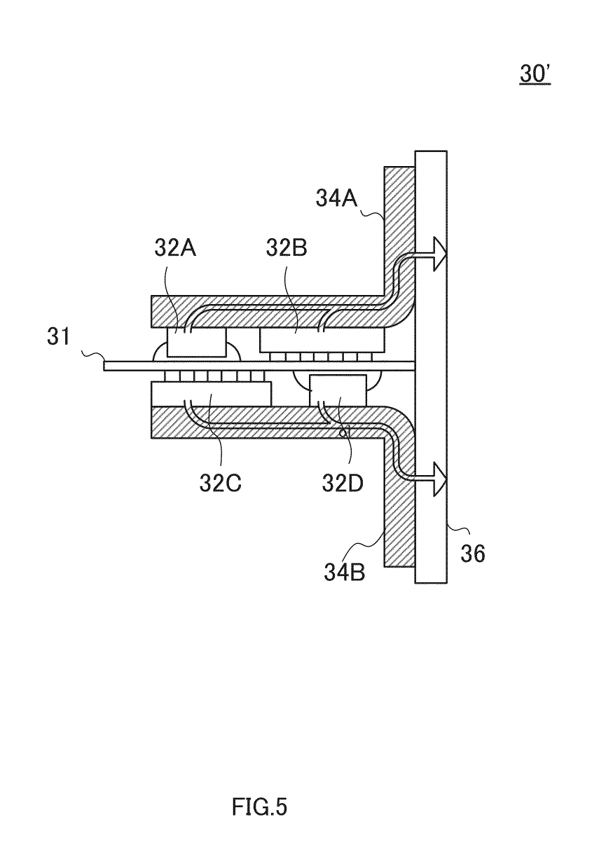

FIG. 5 is a schematic view illustrating another example of an electronic device into which the anisotropic heat-conductive sheet is incorporated. In FIG. 5, components that are identical to or have identical function to those illustrated in FIG. 4 are given the same reference signs. As illustrated in FIG. 5, heat dissipation structure 30′ includes heat dissipator 36 disposed so as to be spaced from heat sources 32A to 32D disposed on both sides of printed circuit board 31 and intersect printed circuit board 31; anisotropic heat-conductive film 34A disposed in a bent state such that heat sources 32A and 32B are coupled to heat dissipator 36; and anisotropic heat-conductive film 34B disposed in a bent state such that heat sources 32C and 32D are coupled to heat dissipator 36. The lengthwise direction of anisotropic heat-conductive films 34A and 34B in FIG. 5 corresponds to X direction (direction of high tensile modulus of elasticity).

In heat dissipation structure 30′, heat generated from heat sources 32A and 32B disposed on one side of printed circuit board 31 smoothly conducts through anisotropic heat-conductive film 34A in X direction (arrowed direction) to heat dissipator 36 and is removed. Similarly, heat generated from heat sources 32C and 32D disposed on the other side of printed circuit board 31 smoothly conducts through anisotropic heat-conductive film 34B in X direction (arrowed direction) to heat dissipator 36 and is removed. As described above, anisotropic heat-conductive films 34A and 34B exhibit high flexibility and shape retainability, and therefore can be kept bent as illustrated in FIG. 5.

4. Shape-Retaining Fiber

A shape-retaining fiber of the claimed invention includes at least one base layer containing the ethylene polymer, and at least one soft layer containing the polymer material. The “ethylene polymer” in the shape-retaining fiber is the same as the ethylene polymer constituting the base layer of the aforementioned shape-retaining film. The “polymer material” in the shape-retaining fiber is the same as the polymer material constituting the soft layer of the aforementioned shape-retaining film.

The thickness of the shape-retaining fiber of the claimed invention is preferably 200 denier or less, more preferably 100 denier or less, or may be made more smaller. The thickness of the shape-retaining fiber is preferably of the order of several denier when the fibers are gathered and bundled into a micro-multifilament. Denier is the mass in grams of 9,000 meters of fiber. The fiber thickness greatly affects the texture (e.g., softness) of s fabric woven from the fiber. The fiber length of the shape-retaining fiber may be appropriately adjusted according to the intended application.

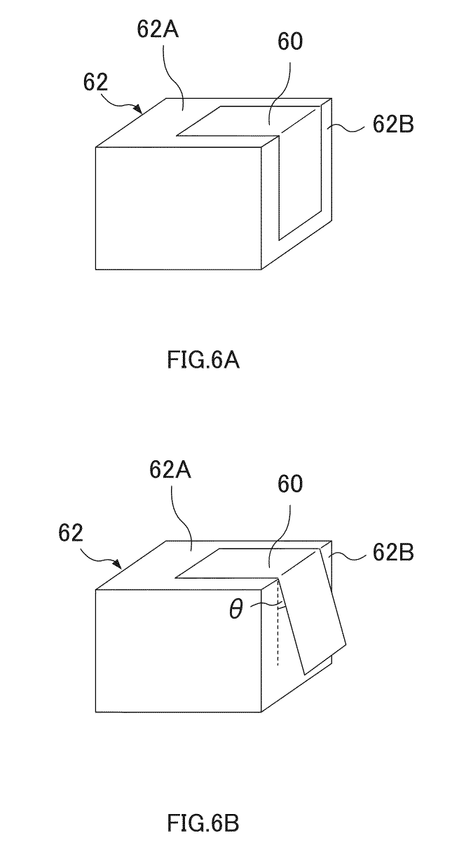

The shape-retaining fiber of the claimed invention exhibits superior shape retainability. Shape retainabilty is indicated by an angle of recovery from 90° bending. The shape-retaining fiber of the claimed the present invention exhibits an angle of recovery from 90° bending of 35° or less. The angle of recovery from 90° bending for the shape-retaining fiber is considered as the angle of recovery from 90° bending of a sheet (shape-retaining film) from which the fiber is produced by cutting. The angle of recovery from 90° bending of the shape-retaining film can be measured in the procedure described below. Specifically, the shape-retaining film is cut into a test specimen which is 10 mm in width (dimension in the direction perpendicular to the direction in which molecular chains of polyethylene are fully extended) and 50 mm in length (direction in which molecular chains of polyethylene are fully stretched). Test specimen 60 is then bent at 90° along a right-angled corner (two intersecting surfaces 62A and 62B) of steel article 62, and kept bent for about 5 seconds (see FIG. 6A). Thereafter, with test specimen 60 secured to surface 62A, the bending force is released so that specimen 60 is allowed to be separated from surface 62B, and angle θ formed between specimen 60 and surface 62B is measured as an angle of recovery (see FIG. 6B). The angle of recovery from 90° bending can be measured at 23° C. and 55% relative humidity.

The tensile modulus of elasticity of the shape-retaining fiber of the claimed invention is 10 to 50 GPa, preferably 13 to 50 GPa. When the tensile modulus of elasticity of the shape-retaining fiber is less than 10 GPa, it is difficult to confer to the fiber a sufficient shape retainability. On the other hand, when the tensile modulus of elasticity of the shape-retaining fiber exceeds 50 GPa, it may result in failure to weave the fiber into fabric because the fiber becomes breakable. The tensile modulus of elasticity of the shape-retaining fiber is considered as the tensile modulus of elasticity of the film (shape-retaining film) from which the fiber is produced by cutting.

The shape-retaining fiber of the claimed invention can be produced by cutting the aforementioned shape-retaining film. The tensile modulus of elasticity of the resultant shape-retaining fiber can be adjusted by adjusting the stretch ratio of uniaxial stretching of the shape-retaining film. The higher the stretch ratio for uniaxial stretching, the longer the extended molecular chains of polyethylene become, resulting in the stretched polyethylene film having an increased tensile modulus of elasticity.

The shape-retaining fiber of the claimed invention exhibits high thermal conductivity in the lengthwise direction. More specifically, the shape-retaining fiber can have a thermal conductivity in the lengthwise direction of 3 to 30 W/mk, or 10 to 30 W/mK. The thermal conductivity of the shape-retaining fiber is considered as the thermal conductivity of the film (shape-retaining film) from which the fiber is produced by cutting.

The thermal conductivity in the lengthwise direction of the shape-retaining fiber may be adjusted by the stretch ratio for uniaxial stretching carried out in the fiber production process (later described). Uniaxial stretching causes the polyethylene contained in the shape-retaining fiber to exhibit anisotropy between the stretch direction and the direction perpendicular to the stretch direction. The anisotropy increases with increasing stretch ratio for uniaxial stretching. Polymers that exhibit anisotropy (especially crystalline polymers) exhibit improved thermal conductivity in stretch direction compared to polymers that exhibit isotropy.

The shape-retaining fiber of the claimed invention may be used in various applications. The shape-retaining fiber can be used as a stopper like a wire, and when it is used as fiber for fabric, shape retainability can be conferred to the fabric.

5. Applications of Shape-Retaining Fiber

Specific examples of the applications of the shape-retaining fiber of the claimed invention include clothes (e.g., shirts, suits, blazers, blouses, coats, jackets, blousons, jumpers, vests, dresses, trousers, skirts, pants, underwears (e.g., slips, petticoats, camisoles, and brassieres), socks, Japanese clothes, obi material, and gold brocades), cool feeling clothes, neckties, handkerchiefs, tablecloths, gloves, footwears (e.g., sneakers, boots, sandals, pumps, mules, slippers, ballet shoes, and kung-fu shoes), mufflers, scarfs, stoles, eye masks, towels, pouches, bags (e.g., tote bags and shoulder bags, handbags, pocheties, shopping bags, eco-bags, rucksacks, daypacks, sport bags, Boston bag, waist bags, waist pouches, clutch bags, vanity bags, accessory pouches, mother bags, party bags, and kimono bags), porch/cases (e.g., tissue cases, glasses cases, pen cases, book jackets, game porches, key cases, and holders for a commuter pass), wallets, headgears (e.g., hats, caps, caskets, hunching caps, ten-gallon hats, flop hats, sun visors, berets, helmets, and hoods), belts, aprons, ribbons, corsages, brooches, curtains, wallcloths, seat covers, sheets, quilts, quilt covers, blankets, pillows, pillow cases, sofas, beds, baskets, lapping materials, room decorations, car accessories, artificial flowers, masks, dressings, ropes, nets, fishing nets, cement reinforcing materials, screen printing meshes, filters (e.g., for cars and household appliances), meshes, sheets (e.g., agricultural sheets and and leisure sheets), textiles (for public works and construction works), and filtration cloths. Each of the aforementioned articles may be made up of the shape-retaining fiber of the claimed invention entirely or only in part where shape retainability is required. Alternatively, the shape-retaining fiber may be combined with other materials, e.g., by lamination or stitching. For example, the shape-retaining fiber can be combined with fabric, non-woven fabric, etc.

The shape-retaining fiber of the claimed invention possesses characteristics of light weight, toughness, easy deformation, etc. Accordingly, the shape-retaining fiber of the claimed invention and a fabric made of the same can be used in reinforcing materials where glass fibers, carbon fibers, aramid fibers etc. are used. Specifically, they can be for used for the reinforcement of airplanes, automobiles and trains, as we as in their accessories. In particular, the shape-retaining fiber of the claimed invention and a fabric made of the same can be used for car bodies, air bags, seat belts, doors, bumpers, cockpit modules, console boxes, glove boxes, etc., of cars.

3.2 Process for Producing Shape-Retaining Fiber

The shape-retaining fiber of the claimed invention can be produced by a process that includes: 1) a first step of providing an original film that includes at least one base layer containing an ethylene polymer, and at least one soft layer containing a polymer material; 2) a second step of stretching (preferably uniaxially stretching) the original film at a stretch ratio of 10 to 30, at a temperature above the melting point Tm2 of the polymer material; and 3) a third step of cutting the resultant shape-retaining film by the method called micro-slitting. Because high-density polyethylenes are Sometimes not easily melt-spun, the film is preferably defibrated (cut) into fibers. These first and second steps are the same as the first and second steps of the aforementioned process for producing a shape-retaining film.

The shape-retaining film to be cut in the third step is preferably a three-layered laminate that includes two base layers and one soft layer provided between the base layers. The reason for this is that such a three-layered laminate is more easily cut than a two-layered laminate consisting of one base layer and one soft layer. Furthermore, a shape-retaining fiber prepared by cutting such a three-layered laminate can be readily processed into a fabric and/or the like.

Alternatively, the shape-retaining film to be cut in the third step may be a laminated film having another layer disposed on its surface. This layer may be a layer for conferring good appearance to the shape-retaining fiber to be produced. The layer for conferring good appearance is, for example, a layer having Metallic luster or hue. For example, a metal layer may be laminated on the shape-retaining film. The metal layer may be formed by means of any of the methods known in the art, e.g., by vacuum deposition or sputtering.

The shape-retaining fiber can be produced by cutting the shape-retaining film or a laminate of the shape-retaining film and an optional layer by micro-slitting. Micro-slitting is the process wherein a film to be cut is fed into a micro slitter equipped with a slitting blade such as laser blade or rotary shear and is cut into fibers.

The direction in which the shape-retaining film is cut into fibers is preferably parallel to the direction in which molecular chains of polyethylene in the shape-retaining film are fully extended (i.e., primary stretch direction). This makes it possible to provide a shape-retaining fiber that exhibits superior shape retainability and thermal conductivity.

The slit width of the slitting, blade is preferably 100 to 500 μm. The slit width corresponds to the dimension of the long side of a cross-section of the resultant shape-retaining fiber.

7. Fabric

A fabric is constructed in film form by interlacing the shape-retaining fibers of the claimed invention over and under each other in a regular pattern. Either all or some of the fibers of a fabric may be the shape-retaining fiber of the claimed invention. By employing the shape-retaining fibers of the claimed invention for some or all of the fibers of a fabric, it is possible to confer shape retainability to the fabric.

There are no particular limitations to the weave construction of the fabric; it may be formed with a fundamental weave construction such as plain weave, diagonal weave or satin weave, or may be formed with a stereoscopic construction such as weft knit, warp knit, circular knit or cross knit. The fabric may have three-dimensional structure. A fabric having three-dimensional structure refers to a fabric in which fibers are woven not only in two dimensions but also along the thickness of the fabric to provide stereoscopic form.

Among fibers of the fabric having three-dimensional structure, at least some or all of fibers woven or knitted along the thickness are preferably the shape-retaining fibers of the claimed invention. As described above, the shape-retaining fiber of the claimed invention exhibits high thermal conductivity in the lengthwise direction. Thus, when the shape-retaining fibers of the claimed invention are oriented in the fabric thickness direction of the fabric, thermal conductivity in the thickness direction is increased.

Examples of the fabric having three-dimensional structure are disclosed for instance in JP-A No. 2001-513855. JP-A No. 2001-513855 discloses three-dimensional fabrics that have two pairs of mutually perpendicular lateral threads running through a plane and vertical threads running in thickness direction. By replacing the vertical threads by the shape-retaining fibers of the claimed invention, thermal conductivity in thickness direction increases.

The shape-retaining fiber of the claimed invention may be turned into a twisted yarn. There are no particular limitations to the method of obtaining a twisted yarn. Specific examples of the method of obtaining a twisted yarn include: 1) twisting a single yarn of the shape-retaining fiber of the claimed invention; 2) twisting together a plurality of single yarns of the shape-retaining fiber of the claimed invention; 3) twisting together a single yarn of the shape-retaining fiber of the claimed invention and one or more different yarns; 4) twisting a single yarn of the shape-retaining fiber of the claimed invention and winding the same around a core yarn; 5) winding a plurality of single yarns of the shape-retaining fiber of the claimed invention around a core yarn; 6) winding a single yarn of the shape-retaining fiber of the claimed invention and one or more different yarns around a core yarn; and 7) twisting together one or more different yarns and winding the same around a single yarn of the shape-retaining fiber of the claimed invention (core yarn). Note that the obtained twisted yarn may be woven into a fabric. By turning the shape-retaining fiber into a twisted yarn, the fibers contained in the twisted yarn have randomized lengths. Thus, when the shape-retaining fiber of the claimed invention in the form of twisted yarn is woven into a fabric, the fabric exhibits increased thermal conductivity in film thickness direction. By turning the shape-retaining fiber into a twisted yarn, it is more easily made into a fabric.

The shape-retaining fibers of the claimed invention may be bundled into micro-multifilaments. Preferably, the fibers to be bundled into micro-multifilaments are generally split into fine fibers of the order of several denier each By weaving a fabric from the micro-multifilaments, fabric's texture and transparency can be adjusted.

There are no particular limitations to the density of the fabric of the claimed invention. An increase in the density of the shape-retaining fiber leads to increased thermal conductivity.

The fabric of the claimed invention may be used in a variety of applications; for example, clothes in which the fabric is used exhibits high heat dissipation,

### EXAMPLES

The claimed invention will now be described in more detail based on Examples, which however shall not be construed as limiting the scope of the invention thereto.

1. Components

HDPE: high-density polyethylene (“NOVATEC HD HB530” Japan Polyethylene Corporation; density=965 kg/m³, Mw/Mn=15.8, MFR at 190° C.=0.36 g/10 min)

LLDPE (1): linear low-density polyethylene (“EVOLUE H SP4505” Prime Polymer Co., Ltd.)

LLDPE (2): linear low-density polyethylene (“MORETEC 0278G” Prime Polymer Co., Ltd.)

Thermoplastic elastomer; α-olefin copolymer (“TAFMER A4090” Mitsui Chemicals, Inc.; Melting point Tm2: 77° C.)

2. Production of Shape-Retaining Film

### Example 1

HDPE was used as the raw material of base layers A and B, and the thermoplastic elastomer as the raw material of the soft layer. The raw materials for the respective layers were melted using a 3-layer co-extruder equipped with a full flight screw. The three different molten resins were co-extruded at 260° C. with a multi-layer die to form a laminate that includes, in order, base layer A, soft layer, and base layer B. In this way an original film was produced. The original film was then uniaxially stretched at 120° C. with a uniaxial roll stretcher to prepare a 40 μm-thick shape-retaining film made of high-density polyethylene, stretched 15 times the length (dimension in stretch direction) of the original film.

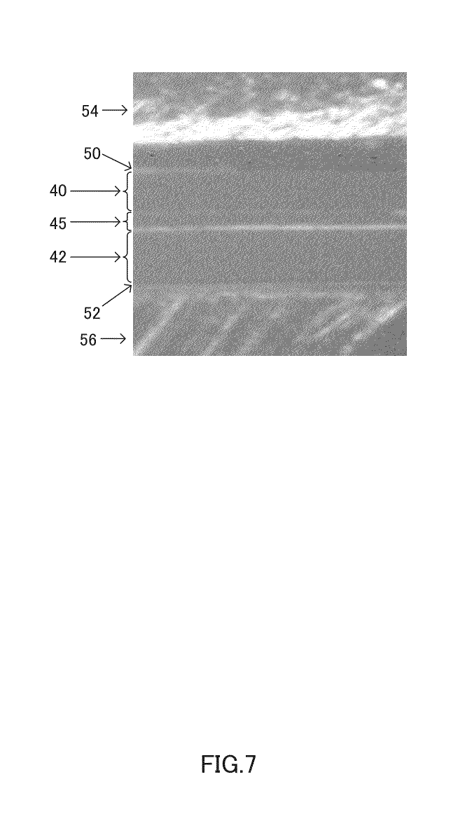

The uniaxially-stretched film was cut with a single-edged knife, and a cross section of the film was observed with a microscope (KEYENCE). FIG. 7 is an optical microscopic image of a cross section of the uniaxially-stretched film prepared in Example 7. In FIG. 7, a cross section out perpendicularly to the stretch direction of the film is depicted. As depicted in FIG. 7, the uniaxially-stretched film produced includes, in order, base layer B 42, soft layer 45, and base layer A 40 laminated on top of one another. In FIG. 7, reference signs 50 and 52 denote a film surface, and reference signs 54 and 56 a jig used to secure the film.

### Example 2

A uniaxially-stretched film was prepared in the same manner as in Example 1 except that the original film was stretched at a stretch ratio of 20. The produced uniaxially-stretched film exhibited a thermal conductivity in stretch direction (i.e., X direction) of 7.86 W/mK, and a thermal conductivity in the direction substantially perpendicular to X direction (i.e., Y direction) of 0.289 W/mK.

### Comparative Example 1

HDPE was used as the raw material, and melt-kneaded at 260° C. using an extruder. The melt-kneaded material was ejected from a T-die to produce a 600 μm-thick original film. The original film was then uniaxially stretched at 120° C. with heating roll to prepare a 40 μm-thick shape-retaining film made of high-density polyethylene, stretched 15 times the length (dimension in stretch direction) of the original film.

### Comparative Example 2

A uniaxially-stretched film was prepared in the same manner as in Example 1 except that 100 parts by weight of HDPE mixed with 3 parts by weight of LLDPE (1) was used as the raw material and that a single-layered original film was produced by extrusion.

### Comparative Example 3

A uniaxially-stretched film was prepared in the same manner as in Comparative Example 2 except that 100 parts by weight of HDPE mixed with 10 parts by weight of LLDPE (1) was used as the raw material.

### Comparative Example 4

A uniaxially-stretched film was prepared in the same manner as in Comparative Example 2 except that 100 parts by weight of HDPE mixed with 3 parts by weight of LLDPE (2) was used as the raw material.

### Comparative Example 5

A uniaxially-stretched film was prepared in the same manner as in Comparative Example 2 except that 100 parts by weight of HDPE mixed with 10 parts by weight of LLDPE (2) was used as the raw material.

3 Evaluation Methods

(1) Density

The density of the base layer was measured in accordance with JIS K7112 D using an ethanol-water solution as immersion solution.

(2) Tensile Modulus of Elasticity

The shape-retaining film was cut into a strip-shaped specimen which was 10 mm in width (dimension in a direction perpendicular to the stretch direction of the uniaxially-stretched film) and 120 mm in length (dimension in the stretch direction of the uniaxially-stretched film). The test specimen was measured for tensile modulus of elasticity using a tensile tester under the following condition: chuck-to-chuck distance=100 mm, and tensile rate100 mm/min. Tensile modulus of elasticity was measured for 5 test specimens, and an average was calculated. The measurements were made at 23° C. and 55% relative humidity.

(3) Angle of Recovery

A test specimen was prepared by cutting the shape-retaining film into a strip which was 10 mm in width (dimension in the direction perpendicular to the stretch direction of the uniaxially-stretched film) and 50 mm in length (dimension in the stretch direction of the uniaxially-stretched film). As illustrated in FIG. 1A, test specimen 10 was fitted on 1.2 mm-thick plate 12 to cover the bottom, edge and top surfaces. In this way specimen 10 was bent at 180°, and kept bent (with a hand or placing a 1 kg weight) for approximately 30 seconds. Thereafter, as illustrated in FIG. 1B, the bending force was released (by taking the hand off or removing the weight from the film). 30 seconds after releasing the bending force, angle θ between top surface 12A of plate 12 and test specimen 10 was measured to find an “angle or recovery.” The measurements were made at 23° C. and 55% relative humidity.

(4) Tear Resistance

Using an Elmendorf tear tester (TOYO SEIKI SEISAKU-SHO, Ltd., F.S=1,000 mN)), a test specimen that comprise a pack of 16 film pieces, each measuring in 63 mm in width and 75 mm in length and having a 20 mm initial cut, was torn in a direction parallel to the stretch direction, and the force required to cause tearing was measured to find the tear strength.

4. Evaluation Results

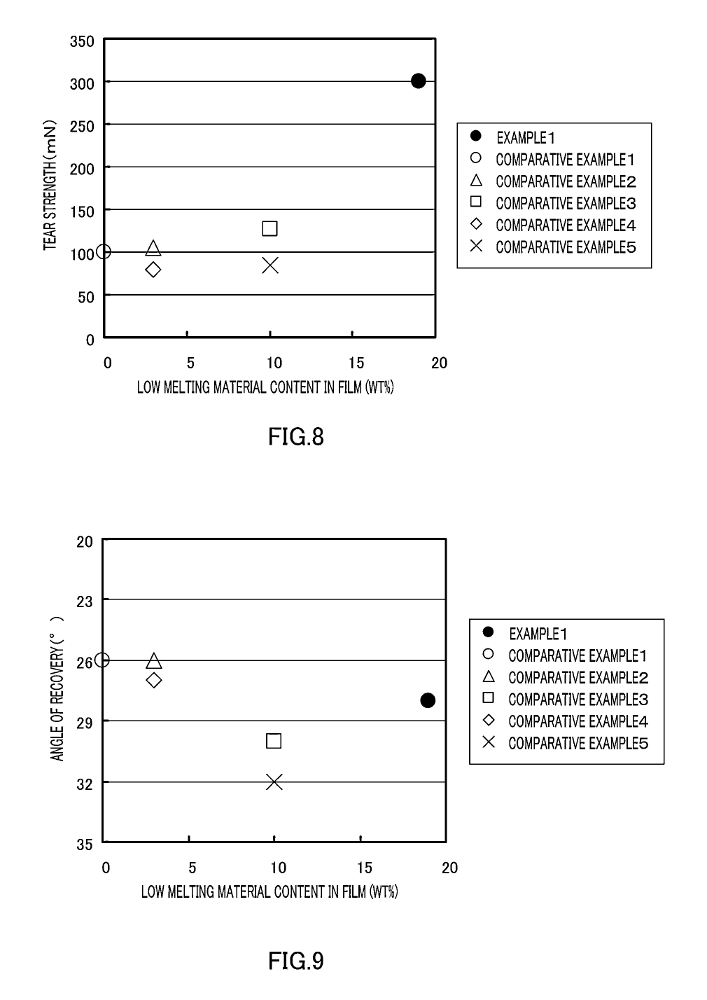

The shape-retaining films prepared in Example 1 and Comparative Examples 1 to 5 were measured for their tensile modulus of elasticity, angle of recovery, and tear resistance. The results are given in Table 1. A graph showing a plot of tear strength (mN) versus low melting material content (wt %) in film is given in FIG. 8. Further, a graph showing a plot of angle of recovery (°) versus low melting material content (wt %) in film is given in FIG. 9.

TABLE 1

| | | | | | Comp. | Comp. | Comp. | Comp. | Comp. |
|---|---|---|---|---|---|---|---|---|---|
| | | | Ex. 1 | Ex. 2 | Ex. 1 | Ex. 2 | Ex. 3 | Ex. 4 | Ex. 5 |
| Film structure | Base layer A | Density (kg/m³) | 965 | 965 | 965 | — | — | — | — |
| | | Melting point Tm1 (° C.) | 133 | 133 | 133 | — | — | — | — |
| | | Mw/Mn | 15.8 | 15.8 | 15.8 | — | — | — | — |
| | | Thickness (μm) | 16 | 20 | 40 | 40 | 40 | 40 | 40 |
| | Soft layer | Melting point Tm2 (° C.) | 77 | 77 | — | — | — | — | — |
| | | Thickness (μm) | 8 | 10 | — | — | — | — | — |
| | Base layer B | Density (kg/m³) | 965 | 965 | — | — | — | — | — |
| | | Melting point Tm1 (° C.) | 133 | 133 | — | — | — | — | — |
| | | Mw/Mn | 15.8 | 15.8 | — | — | — | — | — |
| | | Thickness (μm) | 16 | 20 | — | — | — | — | — |

| | | | | | | | | |
|---|---|---|---|---|---|---|---|---|
| | Low melting material content in film (wt %) | 19 | 19 | 0 | 3 | 10 | 3 | 10 |
| | Total thickness (μm) | 40 | 50 | 40 | 40 | 40 | 40 | 40 |
| Production | Stretch ratio | 15 | 20 | 15 | 15 | 15 | 15 | 15 |
| conditions | Stretching temperature (° C.) | 120 | 120 | 120 | 120 | 120 | 120 | 120 |
| Evaluation | Tensile modulus of elasticity (GPa) | 13 | 17 | 15 | 15 | 14 | 15 | 14 |
| results | Angle of recovery (°) | 28 | 22 | 26 | 26 | 30 | 27 | 32 |
| | Tear strength (mN) | 300 | 340 | 100 | 105 | 127 | 80 | 85 |

As seen in Table 1 and FIG. 8, it is obvious that the uniaxially-stretched film (shape-retaining film) prepared in Example 1 exhibited much higher tear resistance than those prepared in Comparative Examples 1 to 5. Moreover, as seen in FIGS. 8 and 9, the increase in the low melting material (i.e., LLDPE) content improved tear resistance, but increased the angle of recovery (see Comparative Examples 1 to 5). By contrast, as is obvious from the results of Examples 1 and 2, laminating together a base layer and a soft layer that contains a low melting material (thermoplastic elastomer) without virtually mixing the low melting material into the base layer significantly improved tear resistance with only limited increase in recovery angle, enabling the shape-retaining film to retain high shape retainability. Note that the uniaxially-stretched film prepared in Example 2 is thicker than the uniaxially-stretched film prepared in Example 1 and therefore retained high tear resistance even though it was stretched at a high stretch ratio.

### INDUSTRIAL APPLICABILITY

The shape-retaining film of the claimed invention exhibits superior shape retainability as well as high tensile modulus of elasticity and good lengthwise tear resistance, and therefore is suitable as an anisotropic heat-conductive film for heat dissipation devices incorporated in various electronic devices, and as a source material of shape-retaining fibers.

### REFERENCE SIGNS LIST

10, 60 Test specimen
12 Plate
12A Top surface of plate
15 Packaging material
15A Opening
20 Heat dissipation device
22 Heat source
24, 34, 34A, 34B, Anisotropic heat-conductive film
26, 36 Heat dissipator
31 Printed circuit board
32, 32A, 32B, 32C, 32D Heat source
30, 30′ heat dissipation structure
40 Base layer A
42 Base layer B
45 Soft layer
50, 52 Film surface
54, 56 Jig
62 Steel material
12A, 12B surface

1. A shape-retaining film comprising:
at least one base layer containing an ethylene polymer, the ethylene polymer having a density of 900 kg/m³ or more and a ratio of weight-average molecular weight (Mw) to number-average molecular weight (Mn) of 5 to 20; and
at least one soft layer containing a polymer material,
wherein the ethylene polymer is either an ethylene homopolymer or an ethylene-α-olefin copolymer containing less than 2 wt % C₃₋₆ α-olefin unit,
wherein a melting point Tm2 of the polymer material is lower than a melting point Tm1 of the ethylene polymer, and
wherein the shape-retaining film has a tensile modulus of elasticity of 10 to 50 GPa, and an angle of recovery from 180° bending of 65° or less.

2. The shape-retaining film according to claim 1, wherein the shape-retaining film is a laminate in which the soft layer is directly laminated onto one side of the base layer,

3. The shape-retaining film according to claim 1, wherein the shape-retaining film is a laminate in which the at least one base layer comprises two base layers, and the soft layer is provided between the two base layers,

4. The shape-retaining film according to claim 1, wherein the melting point Tm2 of the polymer material is lower than the melting point Tm1 of the ethylene polymer by 5° C. or more.

5. The shape-retaining film according to claim 1, wherein the melting point Tm2 of the polymer material is 125° C. or below.

6. The shape-retaining film according to claim 1, wherein the polymer material is at least one polymer material selected from the group consisting of a hydrocarbon plastic, a vinyl plastic, and a thermoplastic elastomer.

7. The shape-retaining film according to claim 1, wherein an overall thickness of the soft layer is 5 to 40% of an overall thickness of the base layer.

8. The shape-retaining film according to claim 1, wherein the shape-retaining film is a uniaxially-stretched film.

9. The shape-retaining film according to claim 8, wherein a tensile modulus of elasticity in stretch direction of the shape-retaining film is 10 to 50 GPa, and a tensile modulus of elasticity in a direction substantially perpendicular to the stretch direction is 6 GPa or less.

10. The shape-retaining film according to claim 1, wherein the shape-retaining film has a thickness of 20 to 100 μm.

11. A process for producing the shape-retaining film according to claim 1, comprising:
a first step of providing an original film, the original film including at least one base layer containing an ethylene polymer, the ethylene polymer having a density of 900 kg/m³ or more and a ratio of weight-average molecular weight (Mw) to number-average molecular weight (Mn) of 5 to 20, and at least one soft layer containing a polymer material, the ethylene polymer being either an ethylene homopolymer or an ethylene-α-olefin copolymer containing less than 2 wt % C₃₋₆ α-olefin unit, a melting point Tm2 of the polymer material being lower than a melting point Tm1 of the ethylene polymer; and
a second step of stretching the original film at a stretch ratio of 10 to 30.

12. A laminated tape comprising:
the shape-retaining film according to claim 1; and
a tacky layer disposed on a partial or entire surface of at least one side of the shape-retaining film.

13. An anisotropic heat-conductive film comprising the shape-retaining film according to claim 1.

14. A shape-retaining fiber comprising:
at least one base layer containing an ethylene polymer, the ethylene polymer having a density of 900 kg/m³ or more and a ratio of weight-average molecular weight (Mw) to number-average molecular weight (Mn) of 5 to 20; and
at least one soft layer containing a polymer material,
wherein the ethylene polymer is either an ethylene homopolymer or an ethylene-α-olefin copolymer containing less than 2 wt % C₃₋₆ α-olefin unit,
wherein a melting point Tm2 of the polymer material is lower than a melting point Tm1 of the ethylene polymer, and
wherein the shape-retaining fiber has a tensile modulus of elasticity of 10 to 50 GPa, and an angle of recovery from 90° lengthwise bending of 35° or less.
